(19) United States
(12) Patent Application Publication
(10) Pub. No.: US 2025/0193062 A1
(43) Pub. Date: Jun. 12, 2025

(54) METHODS, SYSTEM, AND APPARATUS FOR COMMUNICATING ZERO-PADDED SIGNALS

(71) Applicant: Huawei Technologies Co., Ltd., Shenzhen (CN)

(72) Inventors: Ming Jia, Ottawa (CA); Jianglei Ma, Ottawa (CA)

(21) Appl. No.: 19/062,965

(22) Filed: Feb. 25, 2025

Related U.S. Application Data
(63) Continuation of application No. PCT/CN2022/115240, filed on Aug. 26, 2022.

(51) Int. Cl. H04L 27/26; H04L 25/03

(52) U.S. Cl. CPC H04L 27/2607; H04L 25/03006

(57) ABSTRACT

Methods and apparatus for communicating zero-padded signals related to zero padding of a transmission symbol that is to be transmitted in a wireless communication network. Signaling indicative of such zero padding is communicated between communication devices, and a zero-padded transmission symbol to which the zero padding has been applied, as well as a cyclic prefix preceding the zero-padded transmission symbol, are transmitted by a transmitting device and received by a receiving device. In some embodiments, the zero padding includes both head zero padding at a head of the transmission symbol and tail zero padding at a tail of the transmission symbol. Zero padding may also be applied to a reference signal sequence upon which a reference signal for channel estimation is based.

### CROSS-REFERENCE TO RELATED APPLICATIONS

This application is a continuation of International Application No. PCT/CN2022/115240, filed on Aug. 26, 2022, the disclosure of which is hereby incorporated by reference in its entirety.

### TECHNICAL FIELD

The present application relates generally to wireless communications, and more specifically to communicating, by transmitting and/or receiving, signals that have been zero padded.

### BACKGROUND

In some wireless communication systems, a cyclic prefix (CP) is used to provide a

guard interval between successive transmission symbols. A guard interval helps reduce possible effects of one symbol on another, such as inter-symbol interference (ISI). For example, in orthogonal frequency division multiplexing (OFDM) systems, a copy of a portion at the end of an OFDM symbol is inserted as a CP before the symbol.

Early research into 5^{th} generation (5G) communication systems recognized that OFDM may be adapted to different 5G requirements using tunable parameters rather than designing for worst-case multipath delay spread, which refers to different delays between signals travelling over the shortest and longest paths in a multipath environment. See J. G. Andrews, “What Will 5G Be?” IEEE JSAC Special Issue on 5G Wireless Communications Systems, September 2014. Indeed, this is applicable not only to OFDM, but also to discrete Fourier transform spread OFDM (DFT-s-OFDM), and more recently to single carrier offset quadrature amplitude modulation (SC-OQAM).

In other work, Berardinelli et al. proposed zero-tail DFT-s-OFDM in 5G networks. See G. Berardinelli, et al., “On the potential of zero-tail DFT-spread-OFDM in 5G networks”, IEEE VTC, 2014, which claimed benefits of not having CP, keeping the same signal symbol length, and being able to adapt to different channel delay spread. Although being able to adapt to different channel delay spread while keeping the same signal symbol length may indeed be interesting features, having no CP might not be good for time-domain synchronization. Also, physical resource block (PRB)-based zero-tail DFT-s-OFDM may have very high overhead. As an example, given 1 subcarrier (out of 12 subcarriers, 8.3% overhead) head zero, and 2 subcarriers (out of 12 subcarriers, 16.7% overhead) tail zeros, the total overhead is 25%.

U.S. Pat. No. 9,313,063 B1, issued Apr. 12, 2016 and entitled “Apparatus and Method for Transmitting Data with Conditional Zero Padding”, proposed conditional zero padding in which symbols are each preceded by a CP of a fixed length and each symbol conditionally includes enough zero padding to avoid ISI between consecutive symbols. If the fixed length for CPs is long enough to avoid ISI between consecutive symbols, then the symbols may omit zero padding, and otherwise the symbols may include enough zero padding to avoid ISI between consecutive symbols.

Padding pattern design is not considered in detail in the above-referenced works, and possible reference signal effects that may arise from zero padding in some scenarios also remain a challenge.

### SUMMARY

Embodiments of the present disclosure relate to zero pattern generation for zero padding of symbols to help reduce or avoid ISI, and corresponding reference signal design.

As will be shown in greater detail below, a circular convolution effect in DFT-s-OFDM, SC-OQAM, and other single-carrier, CP-based waveforms, leads to head pulses in a current symbol causing interference to a subsequent symbol, and tail pulses picking up interference from a previous interfering symbol.

Because head and tail pulses are related to each other in a circular fashion, head zeros and tail zeros are also related to each other. Accordingly, embodiments disclosed herein propose zero padding designs involving any of several schemes for allocating head zeros and tail zeros to avoid or mitigate problematic ISI between consecutive symbols.

According to an aspect of the present disclosure, a method involves communicating, by a first communication device in a wireless communication network, signaling indicative of zero padding to be applied to a transmission symbol that is to be transmitted in the wireless communication network. The zero padding includes both head zero padding at a head of the transmission symbol and tail zero padding at a tail of the transmission symbol. Such a method also involves transmitting, in the wireless communication network by the first communication device to a second communication device, a zero-padded transmission symbol to which the zero padding has been applied, as well as a cyclic prefix preceding the zero-padded transmission symbol.

Another method involves communicating such signaling by a second communication device in a wireless communication network. As above, the signaling is indicative of zero padding to be applied to a transmission symbol that is to be transmitted in the wireless communication network by a first communication device, and the zero padding includes both head zero padding at a head of the transmission symbol and tail zero padding at a tail of the transmission symbol. This method may involve receiving, by the second communication device from the first communication device, a zero-padded transmission symbol to which the zero padding has been applied, and a cyclic prefix preceding the zero-padded transmission symbol.

In apparatus embodiments, an apparatus may include a processor and a non-transitory computer readable storage medium that is coupled to the processor. The non-transitory computer readable storage medium stores programming for execution by the processor.

A storage medium need not necessarily or only be implemented in or in conjunction with such an apparatus. A computer program product, for example, may be or include a non-transitory computer readable medium storing programming for execution by a processor.

Programming stored by a computer readable storage medium may include instructions to, or, via execution by a processor, to cause an apparatus to, perform, implement, support, or enable any of the methods disclosed herein.

For example, the programming may include instructions to, or, via execution by a processor, to cause an apparatus to: communicate, by a first communication device in a wireless communication network, signaling indicative of zero padding to be applied to a transmission symbol that is to be transmitted in the wireless communication network, and transmit, in the wireless communication network by the first communication device to a second communication device, a zero-padded transmission symbol to which the zero padding has been applied and a cyclic prefix preceding the zero-padded transmission symbol. The zero padding includes both head zero padding at a head of the transmission symbol and tail zero padding at a tail of the transmission symbol.

In another embodiment, programming includes instructions to, or, via execution by a processor, to cause an apparatus to: communicate, by a second communication device in a wireless communication network, signaling indicative of zero padding to be applied to a transmission symbol that is to be transmitted in the wireless communication network by a first communication device, and receive, by the second communication device from the first communication device, a zero-padded transmission symbol and a cyclic prefix preceding the zero-padded transmission symbol. The zero padding has been applied to the zero-padded transmission symbol, and includes both head zero padding at a head of the transmission symbol and tail zero padding at a tail of the transmission symbol.

Zero padding for reference signal sequences is also disclosed. One example method involves communicating, by a first communication device in a wireless communication network, signaling indicative of zero padding to be applied to a transmission symbol that is to be transmitted in the wireless communication network; and transmitting, in the wireless communication network by the first communication device to a second communication device, a zero-padded transmission symbol and a reference signal for channel estimation. The zero padding has been applied to the zero-padded transmission symbol, and the reference signal is based on a sequence that is shorter than the zero-padded transmission symbol and is zero padded to a same length as the zero-padded transmission symbol.

According to another method embodiment, a method involves communicating signaling and receiving a zero-padded transmission symbol and a reference signal for channel estimation, but by a second communication device. The signaling is indicative of zero padding to be applied to a transmission symbol that is to be transmitted in the wireless communication network by a first communication device. The zero-padded transmission symbol and the reference signal are received by the second communication device from the first communication device. The zero padding has been applied to the zero-padded transmission symbol, and the reference signal is based on a sequence that, as also described above and elsewhere herein, is shorter than the zero-padded transmission symbol and is zero padded to a same length as the zero-padded transmission symbol.

Features related to zero padding for reference signals are not in any way limited to method embodiments. Apparatus embodiments and computer program product embodiments, examples of which are also provided above and elsewhere herein, are also possible.

Programming stored in a storage medium for execution by a processor may include instructions to, or, via execution by a processor, to cause an apparatus to: communicate, by a first communication device (and/or a second communication device) in a wireless communication network, signaling indicative of zero padding to be applied to a transmission symbol that is to be transmitted in the wireless communication network. Such programming may also include instructions to, or, via execution by a processor, to cause an apparatus to: transmit, in the wireless communication network by the first communication device to a second communication device, a zero-padded transmission symbol and a reference signal for channel estimation; and/or receive, by the second communication device from the first communication device, a zero-padded transmission symbol and a reference signal for channel estimation. Whether such communicating and transmitting are by the first communication device or the communicating and receiving are by the second communication device, the zero padding has been applied to the zero-padded transmission symbol, and the reference signal is based on a sequence that is shorter than the zero-padded transmission symbol and is zero padded to a same length as the zero-padded transmission symbol.

According to another aspect of the present disclosure, a system comprises a first communication device and a second communication device. The first communication device is configured to transmit a zero-padded transmission symbol. The zero-padded transmission symbol comprises a transmission symbol to which zero padding has been applied. The zero padding comprises both head zero padding at a head of the transmission symbol and tail zero padding at a tail of the transmission symbol. The first communication device is further configured to transmit a cyclic prefix preceding the zero-padded transmission symbol. The second communication device is configured to receive from the first communication device the zero-padded transmission symbol comprising the transmission symbol to which zero padding has been applied, and the cyclic prefix preceding the zero-padded transmission symbol.

The present disclosure encompasses these and other aspects or embodiments.

### BRIEF DESCRIPTION OF THE DRAWINGS

For a more complete understanding of the present embodiments, and the advantages thereof, reference is now made, by way of example, to the following descriptions taken in conjunction with the accompanying drawings.

FIG. 1 is a simplified schematic illustration of a communication system.

FIG. 2 is a block diagram illustration of the example communication system in FIG. 1.

FIG. 3 illustrates an example electronic device and examples of base stations.

FIG. 4 illustrates units or modules in a device.

FIG. 5 includes a plot of signal pulse amplitude versus sample index, and illustrates the effect of circular convolution in DFT-s-OFDM.

FIG. 6 illustrates a transmission data format according to an embodiment.

FIG. 7 illustrates a transmission data format according to another embodiment.

FIG. 8 is a flow diagram that is illustrative of embodiments disclosed herein.

FIG. 9 is a signal flow diagram for uplink communications according to an embodiment.

FIG. 10 is a signal flow diagram for downlink communications according to an embodiment.

FIG. 11 is a signal flow diagram for sidelink communications according to an embodiment.

FIG. 12 is a signal flow diagram for sidelink communications according to another embodiment.

FIG. 13 is a block diagram illustrating an example transmitter according to an embodiment.

FIG. 14 is a block diagram illustrating an example receiver according to an embodiment.

FIG. 15 illustrates a frequency domain plot of a zero-padded ZC sequence.

### DETAILED DESCRIPTION OF ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

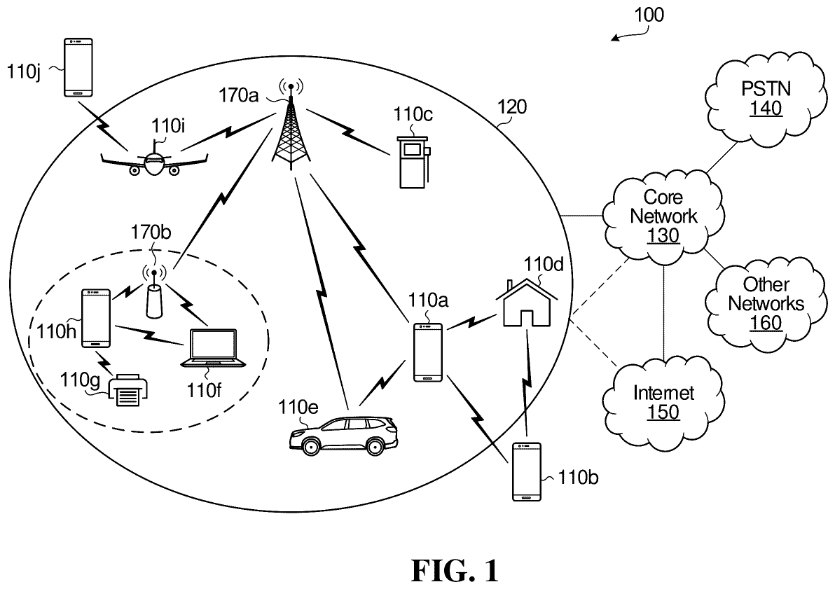

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

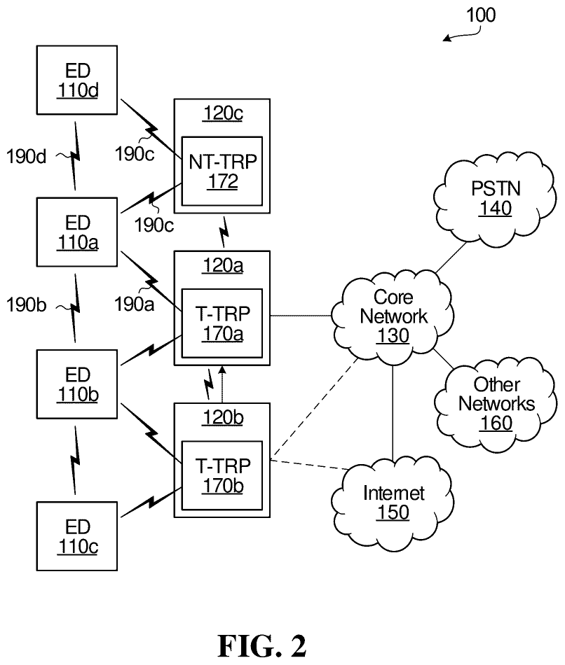

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

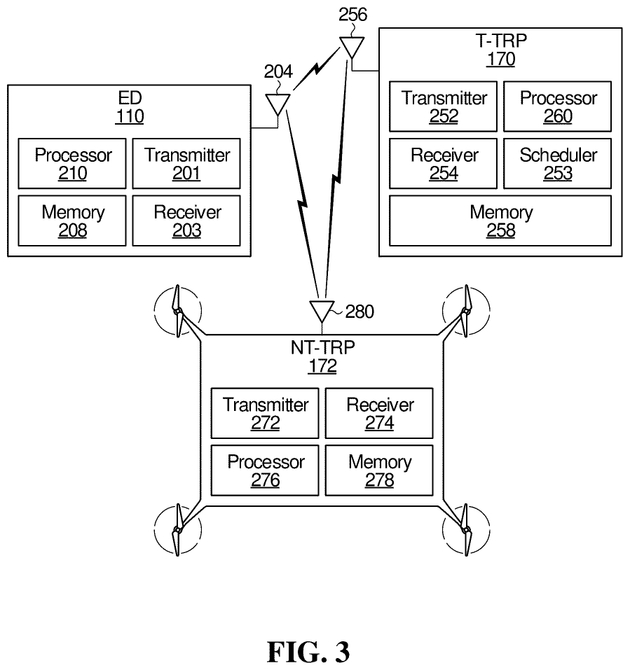

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

The T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output (MIMO) precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

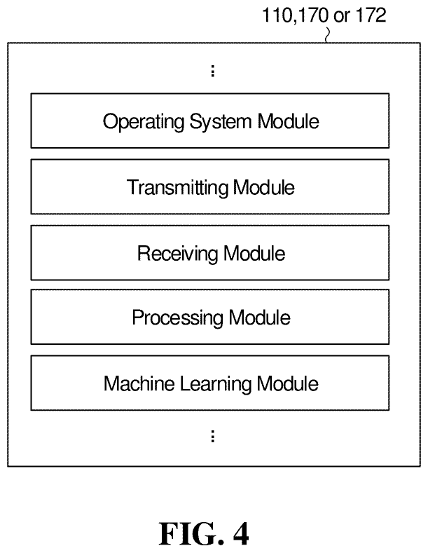

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

Having considered communications more generally above, attention will now turn to particular example embodiments.

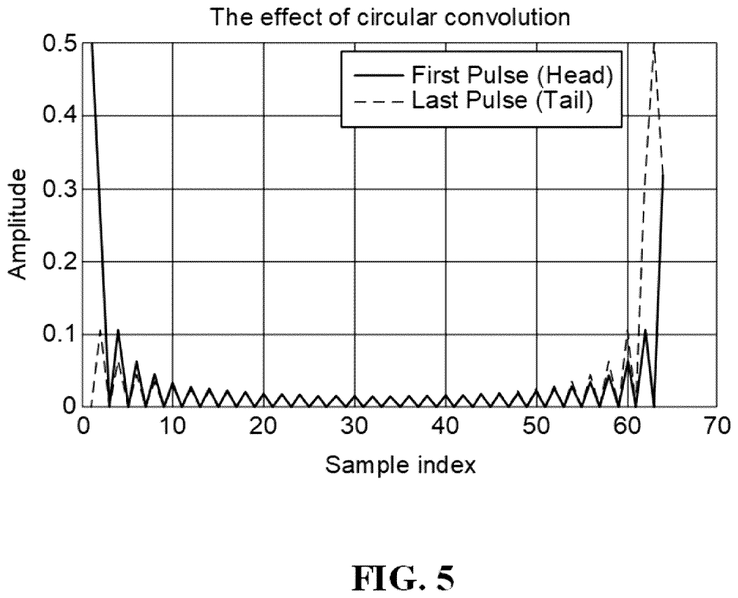

FIG. 5 includes a plot of signal pulse amplitude versus sample index, and illustrates the effect of circular convolution in DFT-s-OFDM. It should be noted that DFT-s-OFDM is only one example; the discussion of signal properties with reference to FIG. 5, and the example embodiments and features disclosed herein, may also or instead apply to other single-carrier, CP-based approaches such as SC-OQAM.

As shown in FIG. 5, the energy of a first head pulse appears at the end of a DFT-s-OFDM symbol; and on the other hand, the energy of a last pulse at the tail of the symbol also appears at the head. Signal pulses are, in effect, circular convolved in the time domain.

This means that head pulses can cause interference to a next DFT-s-OFDM symbol, due to the circular convolution effect in DFT-s-OFDM. This may be the case even if zero padding is used at the tail. Head pulses may still cause significant ISI to a next symbol. Tail pulses can also pick up interference from a previous interfering symbol, also due to the circular convolution effect in DFT-s-OFDM.

Therefore, when CP length is shorter than the multi-path spread, both head pulses and tail pulses can suffer from ISI. In addition, both head pulses and tail pulses can generate interference to a next symbol. These two properties suggest that both head zeros and tail zeros may be useful in conditional zero padding. Head and tail pulses are related to each other in a circular fashion, which means that head zeros and tail zeros are also related to each other. This also means that, to a certain extent, head zeros and tail zeros may be interchangeable. Within this context, embodiments disclosed herein propose zero padding design, which may involve any of several ways to allocate head zeros and tail zeros.

Consider an example in which only one pulse is to be set to zero. In this scenario, the zero pulse should be the first pulse in the head. The first pulse not only suffers most from ISI, but also creates ISI to a next symbol. The next question becomes how to set zeros in a sequential order, when more pulses are to be set to zero.

Setting tail zeros has two effects. Tail zeros cause less ISI to the next symbol. This is somewhat equivalent to setting head pulses to zero, with the difference being that with only tail zeros the guard interval is in a previous symbol rather than a current symbol. With head pulses set to zero, however, the guard interval is in the current symbol, which may be preferable in the sense that a guard interval in the current symbol provides greater control, in the current symbol, over protection against ISI from the previous symbol.

Another effect of setting tail zeros rather than head zeros is that setting tail zeros avoids picking up interference from the head. From FIG. 5, it can be seen that the amplitude of the last tail pulse is lower than the amplitude of the head pulse, which is only partially visible on the scale in the drawing. For example, the amplitude of the tail pulse may be only about 10% of its peak at the head location, and then reduces slowly. If setting one or more of the last samples to zero (i.e., for tail zeros), most of the ISI suffered by the tail pulses can be eliminated.

Multi-path energy appearing in a tail zero-padding region is not lost. It can be recovered during equalization.

Setting head zeros, on the other hand, causes less ISI to a next symbol. For example, after setting the first two samples to zero, most ISI caused by head pulses may be eliminated. Head zeros also have an effect of reducing or avoiding interference from a previous symbol, which is in effect the same as inserting an additional guard interval. Note that in this regard, setting tail pulses to zero and setting head pulses to zero have similar effects, in that both create more guard interval. The difference between these guard interval approaches is that for the former (tail zeros) the guard interval is in the previous symbol, whereas for the latter (head zeros), it is in the current symbol.

For ease of reference, denote a time domain data sequence sᵢ, i=0,1, . . . , L−1, where ‘L’ is the sequence length, and position or index i=0 corresponds to a symbol head. Two applications or scenarios of zero padding are considered below. In a first application or scenario, a common configuration, which may also or instead be referred to as a fixed configuration for example, is applied for all communication devices and therefore all communication devices use the same zero-padding pattern. In a second application or scenario, different configurations may be applied for different communication devices, and therefore communication devices may use different zero-padding patterns, including not using any zero padding. In other words, in the first scenario, even though communications can be time division multiplexing (TDM)-based, each communication device uses the same zero-padding configuration and pattern, whereas in the second scenario, each communication device can use a different zero-padding configuration and pattern.

In the first scenario with a common configuration, according to an embodiment, zero padding is weighted toward tail zeros. For example, a zero-padding pattern, which may also or instead be referred to as a zero-padding sequence for example, may be expressed in terms of positions or indices in a symbol, as i=0, L−1,1, L−2,2, L−3,L−4 . . . , until a target guard interval is reached. Zero-padding to provide a target guard interval does not replace the CP, but rather compensates for CPs that are not of sufficient length to avoid ISI or at least reduce ISI to a target level or by a target amount. Thus, a zero-padding pattern may be designed or otherwise determined based on a target guard interval, ISI avoidance, or a target ISI reduction, for example.

In some implementations, the amount of zero padding, or in other words the length of a zero-padding sequence, is chosen so that a length of the zero padding in addition to the fixed length of a CP is greater than or equal to the delay spread of a multi-path channel. The amount or length of zero padding for a transmitted symbol is a time value in the time domain and may have a discrete value based on how many zeros are to be used for zero padding.

Reference is made herein to zero padding that is sufficient to avoid ISI between consecutive symbols. It is to be understood that avoiding ISI generally means that all, or most, problematic ISI is evaded. However, it is possible that some ISI, which may be referred to as benign ISI and might or might not even be detectable, may remain. Problematic ISI refers to ISI that has a meaningful effect on recovering data. Problematic ISI can make it difficult or even impossible to recover data. Benign ISI generally means ISI that has no meaningful effect on recovering data. No special considerations are required for dealing with benign ISI. ISI may be avoided between a first symbol and a subsequent symbol when most energy from the first symbol, due to channel delay spread, falls within the cyclic prefix of the subsequent symbol, rather than reaching the body or payload data of the subsequent symbol. It should also be noted that embodiments of the disclosure can be used to mitigate or reduce, but not entirely eliminate, problematic ISI. For example, some embodiments may be implemented so that only a target amount such as a percentage of problematic ISI is eliminated, or a target reduction in problematic ISI is provided.

In the above example zero-padding pattern, i=0 indicates allocation of a first head zero at the head of a symbol, i=L−1 indicates allocation of a first tail zero at the tail of the symbol, then another head zero is allocated at i=1, then another tail zero at i=L−2, another head zero at i=2, and another tail zero at i=L−3. This illustrates that a zero-padding pattern may initially alternate between head zeros and tail zeros for the first few head and tail positions (three in this example), and then shift toward tail zeros, beginning at position i=L−4 in this example.

The specific distribution of head zeros and tail zeros in a zero-padding pattern may be different in other embodiments. The example above is intended solely for illustrative purposes. A zero-padding pattern that is weighted toward or favors tail zeros over head zeros may or may not alternate between head zeros and tail zeros to equally distribute zero padding between the first one or more positions at the head and tail of a symbol before distributing more zeros to the tail. In general, according to embodiments herein, in a fixed application or scenario, a zero-padding pattern includes both head zeros and tail zeros, but more tail zeros than head zeros.

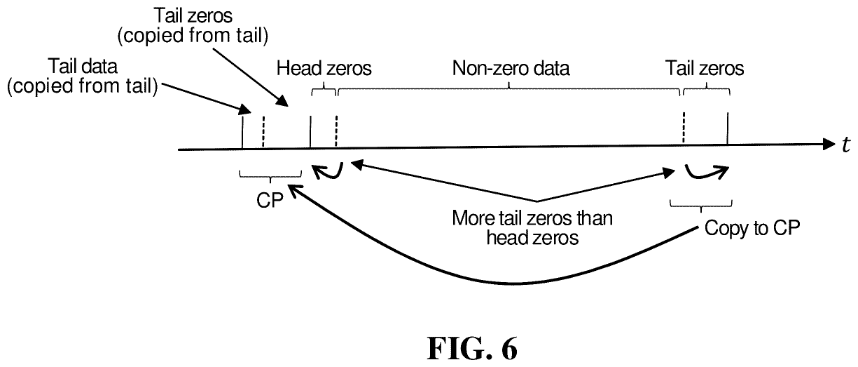

FIG. 6 illustrates a transmission data format according to an embodiment. The embodiment illustrated in FIG. 6 is illustrative of an application or scenario in which a common configuration is applied for all communication devices, and zero padding is weighted toward more tail zeros than head zeros, as shown. FIG. 6 also shows copying of a tail portion of the end of a symbol to the CP before the head of the symbol.

According to terminology as used herein, a transmission symbol refers to what is shown by way of example in FIG. 6 as “Non-zero data”, before padding. A zero-padded transmission symbol includes the head zeros, non-zero data, and tail zeros. The CP is inserted before the zero-padded transmission symbol, but does not itself form part of the a zero-padded transmission symbol to which zero padding has been applied. Although FIG. 6 labels symbol data or payload as “Non-zero data”, this particular label is intended to illustrate that this part of the symbol is not zero padded. A symbol may include one or more zero values that are not part of the zero padding. In order to maintain a fixed symbol length for transmission, zero padding forms part of a zero-padded transmission symbol, which means that a zero-padded transmission symbol may contain less data when there is zero padding relative to a symbol of the same length that does not include any zero padding. Thus, with a fixed symbol length, there is a tradeoff between better protecting data by using zero padding and a higher effective data rate by not using zero padding.

A tail-weighted approach to zero padding has a benefit that head data will not cause high interference to a next symbol, because at least some head zero padding is used even though there are more tail zeros than head zeros in a zero-padding pattern. ISI that may otherwise be caused by head data may be kept under control with some head zero padding, early in a zero-padding pattern. In the above example, head zero padding is allocated in an alternating head-tail part of the zero-padding pattern, but other embodiments are possible. In general, one or more head zeros to reduce head-caused ISI are allocated in a zero-padding pattern, either consecutively to allocate a number of head zeros first or in a head-tail alternating sequence or other “mixed” head-tail initial sequence, and more zeros are allocated to the tail of a symbol to help collect multi-path energy in the tail zero region.

The number of head zeros for a tail-weighted zero-padding approach may be dependent upon any of various factors. Although target ISI reduction or avoidance is expected to be a primary factor, implementation details may also or instead be considered. For example, in SC-OQAM, especially with root raised cosine windowing, head pulse sidelobes tend to attenuate quickly, which means that fewer head zeros may be allocated to achieve an ISI target in a tail-weighted zero-padding approach for SC-OQAM than for DFT-s-OFDM.

These benefits are achieved by allocating more zeros to the tail of a symbol than to the head of the symbol, while maintaining controlled ISI from the head to the next symbol.

In another scenario or application, zero-padding configurations may not be the same for different communication devices. Therefore, a preceding symbol or a next symbol may or may not use zero padding, due to low signal to noise ratio (SNR), for example. This means that, without enough head zero-padding, a current symbol transmitted by one communication device may endure significant ISI from the preceding symbol, and extensive tail zero padding in the current symbol may just be wasted because the next symbol might not necessarily need tail zero padding to deal with ISI.

As explained at least above, tail zero padding can be viewed as a guard interval in a previous symbol. In a scenario that involves different zero-padding configurations, it may be preferred to provide the guard interval in a current symbol, so that each symbol may be better protected, or at least each symbol may better control its own level of protection against ISI, regardless of zero-padding configurations of other communication devices.

Taking this into consideration, according to another embodiment, more head zeros than tail zeros are allocated in a zero-padding pattern. Tail zeros may still be used, to protect tail data from ISI due to the circular convolution nature of DFT-s-OFDM, SC-OQAM, and other single-carrier and CP-based approaches, for example. Therefore, in this scenario, a zero padding pattern may be weighted toward head zero padding, but initially allocate one or more tail zeros as well, before transitioning to become more heavily head-weighted.

As an example, a head-weighted zero-padding pattern may be expressed in terms of positions or indices in a symbol, as i=0,1, L−1,2, L−2,3,4, . . . , until a target guard interval is reached. The specific padding order in a head-weighted zero-padding pattern can vary from this specific example, but in general tail zero-padding is limited to a few pulses, fewer in number than head zeros. Fewer tail zeros for a scenario that involves different zero-padding configurations, relative to a scenario that involves a common zero-padding configuration, loses some of the multi-path energy that is captured in the common configuration scenario, but is in effect a tradeoff to better protect a current symbol and user (associated with a communication device) in the different configuration scenario. Head zeros in the different configuration scenario enable more direct control over a level of ISI protection for a symbol because the guard interval is within the symbol and its own CP, rather than relying on tail zeros in a previous symbol (that may or may not be used) to provide part of the guard interval.

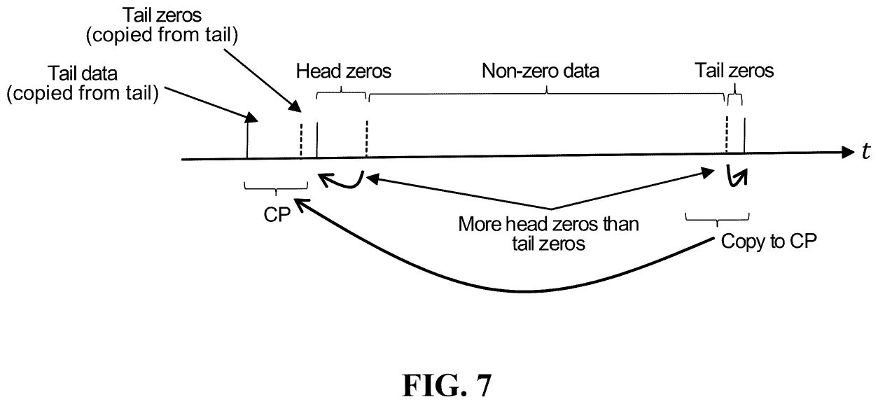

FIG. 7 illustrates a transmission data format according to another embodiment. The embodiment illustrated in FIG. 7 is illustrative of an application or scenario in which zero-padding configurations may be different for different communication devices, and zero padding is weighted toward more head zeros than tail zeros, as shown. The content of FIG. 7 is similar to that of FIG. 6, in that FIG. 7 includes illustrations of copying of a tail portion of the end of a symbol to the CP before the head of the symbol, and symbol data or payload labelled as “Non-zero data”.

A head-weighted approach to zero padding has a benefit that the zero padding is self-contained within a symbol and therefore is decoupled from the zero-padding configurations of other communication devices that transmit previous or next symbols. Another potential benefit is that at least some tail zero padding is used, so that at least some positions at the tail of a symbol are free from ISI or at least have reduced ISI due to the circular convolution nature of data pulses, which occurs at the head.

These benefits are achieved by allocating more zeros to the head of a symbol than to the tail, which achieves “self-contained” protection against ISI while maintaining controlled ISI from the head to the tail of the symbol.

Turning now to signaling, some aspects of the present disclosure relate to signaling design that is intended to optimize or at least improve system performance while using efficient signaling that minimizes or at least reduces added overhead. These benefits may be achieved in some embodiments by exploiting predefined zero-padding patterns that may specify zero-padding order, for example, with consideration of normal CP length.

For example, in some embodiments normal CP length is configured according to a channel profile as part of a numerology configuration, in a similar fashion to the approach implemented in New Radio (NR). However, CP length selection when zero padding is supported can be more aggressive compared to NR, in the sense that a shorter CP can be configured as a common CP length, for example. Additional zero padding can be configured to, in effect, extend the guard interval that would otherwise be provided by a common CP.

One element of signaling design may involve zero-padding patterns. For example, a number of zero-padding patterns, which may also or instead be referred to as zero-padding rules, may be defined. Different zero-padding patterns may be defined for static or semi-static configuration and for dynamic configuration of zero padding.

Zero padding that is to be applied to transmission symbols may be indicated in signaling in any of various ways. A zero-padding pattern that is to be used may itself be indicated in signaling. Multiple zero-padding patterns may be distributed and stored at a communication device, pre-configured at a communication device, or otherwise be available at a communication device, in which case an identifier of a zero-padding may be indicated in signaling to the communication device.

In general, a zero-padding pattern indicator indicates to a communication device how to pad zeros, or how zeros will have been padded in a received zero-padded transmission symbol. For example, a zero-padding pattern indicator in signaling may specify zero-padding order, in terms of positions or indices in a symbol for example. Starting from head zero padding and then tail zero padding, the following are two examples of this type of zero-padding pattern indicator: (0,1, L−1,2, L−2 . . . ), or (0,1, L−1,2, L−1,3,4 . . . ). Other examples of zero-padding pattern indicators include, among others, a total number of zeros padded at the head and tail of a transmission symbol, a number of head zeros, a number of tail zeros, and a ratio between zeros padded at the head and tail.

By specifying padding order, and especially pre-configuring a communication device so that one or more zero-padding patterns in which padding order is inherent or embedded, signaling overhead can potentially be reduced. With one or more padding patterns available at a communication device, signaling might then indicate only a number of zeros to be padded, but not how to pad (i.e., how many zeros in the head and how many zeros in the tail of a transmission symbol), because this information is already provided in the specified padding pattern or order. Therefore, from at least this point of view, it is beneficial for communication standards, for example, to specify one or more padding patterns or padding orders.

For static or semi-static configuration of zero padding, the zero padding may be determined according to, for example, a requirement or target for additional CP length or guard interval, based on one or more of the following, for example: a) a requirement or target for an additional coverage range for communication and/or sensing; and b) a requirement or target for a quality of service (QoS) for different applications, with potentially different zero padding for different applications or services.

In the context of configuration, “static” is intended to indicate that once a parameter or feature such as CP or zero padding is configured, no update is expected. “Semi-static” is intended to indicate that a configuration for a parameter or feature such as CP or zero padding can be updated after it is initially configured, through RRC signaling for example.

A zero-padding indicator for static or semi-static configuration may be distributed to multiple communication devices such as multiple UEs, via broadcast signaling or multi-cast signaling, for example. In some embodiments, a zero-padding indicator is carried in master information block (MIB)/minimum system information and/or system information blocks (SIB)/remaining minimum system information. It is possible that a number of configurations and mapping relation with different parameters or factors may be defined, such as numerology (for example common CP length, subcarrier spacing (SCS)), service requirements, coverage range, channel profile types, etc. Other signaling options include RRC signaling, and PC5 interface signaling in the case of signaling being communicated between UEs. PC5 refers to a reference point where a UE directly communicates with another UE over a direct channel. In this case, communication with a network device such as a base station is not involved in UE-to-UE communications.

For dynamic configuration of zero padding, a zero-padding indicator may be indicated by DCI or RRC signaling, for example, although other signaling options noted elsewhere herein may also or instead be used in dynamic configuration of zero padding.

Dynamic configuration can be applied together with static or semi-static configuration, with further UE-specific optimization. For example, an initial CP configuration can be obtained via RRC signaling, and a CP configuration update is indicated by dynamic signaling.

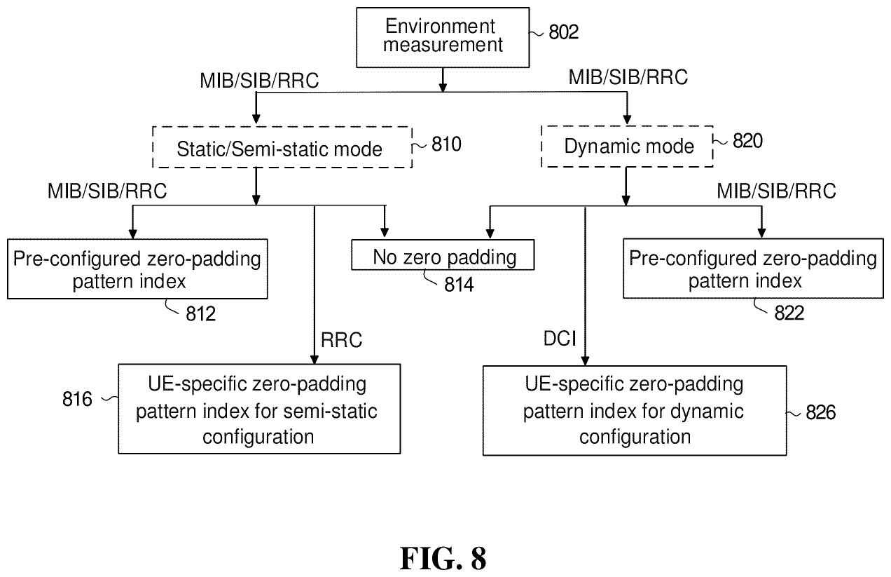

FIG. 8 is a flow diagram that is illustrative of embodiments disclosed herein. In the example shown, a configuration scenario or “mode” may optionally be determined or selected based at least in part on environment measurement at 802. For example, one or more UEs and/or sensors may perform measurements and provide feedback to a network device or other device that is configured to determine, based on the measurements and feedback, whether static or semi-static configuration as shown at 810, or dynamic configuration as shown at 820.

Mode determination or selection, and indication via MIB, SIB, or RRC in the example shown, may be the first steps in a zero-padding process. A UE can obtain a mode indication or information from a network device during initial access, for example, and in some embodiments, once the mode is determined, a UE can obtain a further indication related to zero padding from the network device.

It should be noted, however, that environment measurement at 802 and related MIS/SIB/RRC signaling of configuration mode are optional. One reason to define different modes, two of which are illustrated in FIG. 8, is that different pre-configured, pre-defined, or preset zero-padding configurations can then be defined for the different modes. However, it is also possible that no “mode” is defined, determined, or selected. In a scenario that does not involve different modes for configuring zero padding, more than one (or one set) of pre-configured, preset, or pre-defined configurations may be defined so that a communication device such as a UE will know which type of zero-padding configuration signaling is expected, such as RRC/PC5 (at 816 for example) or DCI/SCI (at 826 for example).

In embodiments that support conditional zero padding, wherein zero padding may or may not be used depending on a target for guard interval and CP length for example, there may be no zero padding as shown at 814, pre-configured zero padding as shown at 812, 822 (which may also or instead be referred to as preset, or pre-defined zero padding), or device-specific zero padding, shown as UE-specific zero padding at 816, 826.

Regarding pre-configured zero padding or pre-configured zero-padding configurations, examples include: a zero-padding pattern that may, but need not necessarily, be associated with particular environment conditions, service type such as QoS requirement, modulation and coding scheme (MCS) level, or configuration mode, and is stored by a communication device; a zero-padding pattern that is specified in a communication standard and is stored by a communication device when implementing the standard; an initial zero-padding pattern that is set when a communication device is powered on and starts communication; and a zero-padding pattern that is set or otherwise configured at an earlier stage of network access or communication setup or configuration.

More generally, a number of zero-padding patterns may be specified, for example, in one or more tables. Some embodiments may involve one table, and other embodiments may involve multiple tables, such as one table for static/semi-static configuration mode and another table for dynamic configuration mode. A zero-padding pattern may include, for example, a padding order that defines a zero padding order in the head and the tail of a transmission symbol, or a head/tail zero-padding ratio.

Various examples of zero-padding indications or pattern indications are provided herein. In a table-based embodiment, each zero-padding pattern may be associated with a table index in a table of zero-padding patterns. The number of bits used for pattern signaling in which an index is indicated is determined by the size of zero-padding table or the number of possible patterns.

FIG. 8 illustrates an option of a zero padding indication in the form of a pattern index at 812, 816, 822, 826, and signaling options are also shown in FIG. 8. These options are intended only as examples, and other embodiments may use different signaling options.

Other configuration features may also or instead be provided. Considering common CP length, for example, in one embodiment common CP length is a cell specific configuration and is carried by system information such as SIB, or there may be pre-defined CP lengths corresponding to different frequency ranges. In another embodiment CP length is a UE-specific semi-static CP configuration, via RRC signaling (which may also be referenced herein as first RRC signaling), together with SCS configuration.

On demand CP adjustment is also possible. For example, static or semi-static additional CP adjustment may be supported. RRC signaling (which may also be referred to herein as second RRC signaling) may indicate a zero-padding configuration, such as a zero-padding pattern indicator in the form of an index from a pre-defined zero-padding table. Another option is to use RRC signaling to indicate additional CP length plus a head and tail zero padding ratio. For dynamic CP adjustment, signaling may be in DCI to indicate a zero-padding configuration, such as a zero-padding pattern index from a pre-defined zero-padding table. DCI may also or instead be used to indicate additional CP length plus a head and tail zero padding ratio.

Again, these options are illustrative and non-limiting examples. Other types of indictors and signaling disclosed herein may also or instead be used.

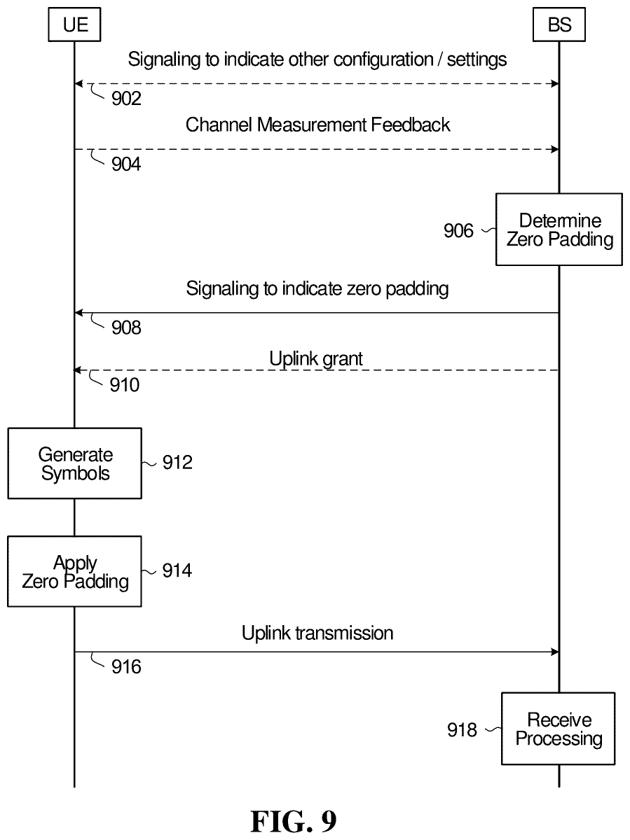

FIG. 9 is a signal flow diagram for uplink communications according to an embodiment. Features illustrated in FIG. 9 include communicating signaling at 908, between a first communication device and a second communication device, in the form of a BS and a UE in the example shown. This communicating at 908 involves transmitting the signaling by the BS to the UE and receiving the signaling by the UE from the BS. The signaling is indicative of zero padding to be applied to a transmission symbol that is to be transmitted in the wireless communication network. The zero padding includes both head zero padding at a head of the transmission symbol and tail zero padding at a tail of the transmission symbol.

Other, optional signaling is illustrated at 902, 904. For example, at 902 signaling to indicate other configuration information and/or settings may be transmitted by the UE to the BS and received by the BS from the UE, and/or transmitted by the BS to the UE and received by the UE from the BS, as indicated by the bidirectional arrow at 902. In some embodiments, as shown at 904 a communication device such as a UE may perform channel measurements and transmit feedback to the BS, and that feedback is received by the BS. For example, a UE may send feedback about a channel delay spread measurement. This is one example, and in another embodiment the measurement is done by the BS.

Such feedback may enable the BS to determine, at 906, the zero padding that is to be applied to a transmission symbol by the UE. Zero padding may be determined based at least in part on such feedback. In the example shown, the UE may send feedback about a channel measurement, but how zero-padding should be done is a decision of the scheduler, which in this example is the BS, or more generally the wireless communication network or system. It should also be noted that feedback from a specific UE that is to transmit a zero-padded transmission symbol is optional. A network, or more specifically a network device in a network, may instead obtain or learn channel environment conditions from feedback that is received from other communication devices, such as separate sensors and/or different UEs, to determine the channel environment in a cell, for example.

One or more other parameters may also or instead be used at 906 to determine the zero padding that is to be applied. A zero padding determination or selection need not be based only, or at all, on feedback from a transmitting device that is to apply zero padding.

An uplink grant is optionally communicated between the BS and the UE at 910, by the BS transmitting grant signaling to the UE and the UE receiving the grant signaling from the BS. Not all embodiments are necessarily grant-based, and therefore an uplink grant need not necessarily be communicated at 910.

At 912, FIG. 9 illustrates generating transmission symbols by the UE. Examples of transmission symbols include OFDM symbols and QAM symbols. Applying zero padding to generate zero-padded symbols is illustrated at 914. Although shown separately in FIG. 9, transmission symbols need not first be generated at 912 and then zero padded at 914. Zero padding may be applied in generating symbols that are to be transmitted. With reference to FIGS. 6 and 7, for example, non-zero data that is to be carried by a transmission symbol may be zero padded with head zeros and tail zeros to generate a zero-padded transmission symbol without explicitly first generating a non-padded transmission symbol.

Returning to FIG. 9, an uplink transmission from the UE to the BS is shown at 916, and represents one example of how a zero-padded transmission symbol may be communicated in a wireless communication network. In this example, communicating the zero-padded transmission symbol involves transmitting the zero-padded transmission symbol by the UE to the BS and receiving the zero-padded transmission symbol by the BS from the UE.

The manner in which a zero-padded transmission symbol is communicated is implementation-dependent. For example, symbol transmission in a DFT-s-OFDM approach involves converting zero-padded transmission symbols to frequency domain, mapping to subcarriers, converting back to time domain, and inserting a CP to generate a time domain signal for transmission. Thus, transmitting a zero-padded transmission symbol may involve these and/or other transmit processing operations, and similarly receiving a zero-padded transmission symbol may involve receive processing operations. Transmit processing is not shown in FIG. 9 or other drawings in order to avoid further congestion in the drawings.

At 918, FIG. 9 illustrates the BS performing receive processing. Receiving a zero-padded transmission symbol may involve, for example, counterparts to transmit processing operations, channel estimation using a reference signal, and decoding data based on the results of the channel estimation.

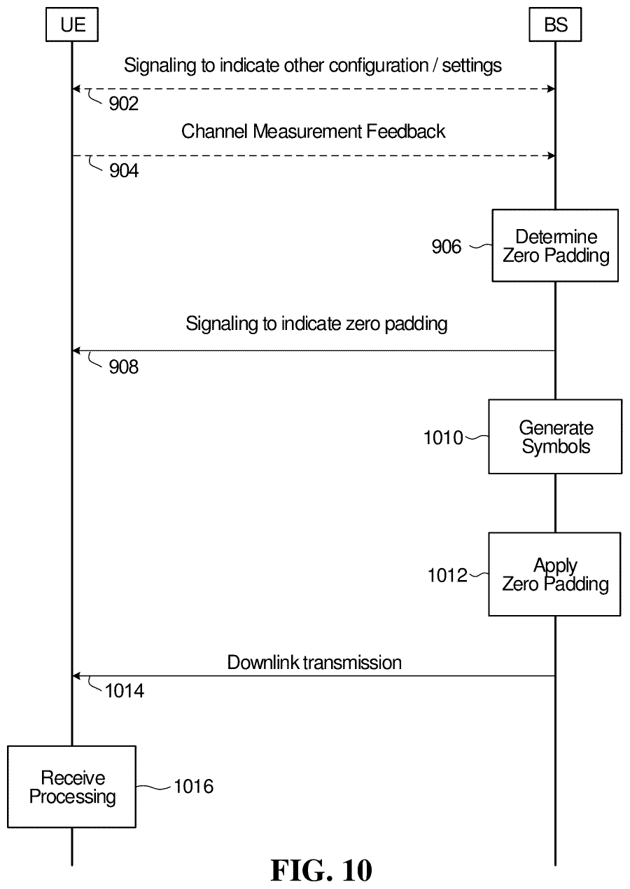

FIG. 10 is a signal flow diagram for downlink communications according to an embodiment. The example in FIG. 10 is similar to the example in FIG. 9, but involves generating a zero-padded transmission symbol at 1010, 1012 by the BS generating a transmission symbol and applying zero padding, and communicating the zero-padded transmission symbol in a downlink transmission at 1014. Receive processing is also shown in FIG. 10 at 1016, but FIG. 10 involves the UE receiving a zero-padded transmission symbol from the BS and performing receive processing.

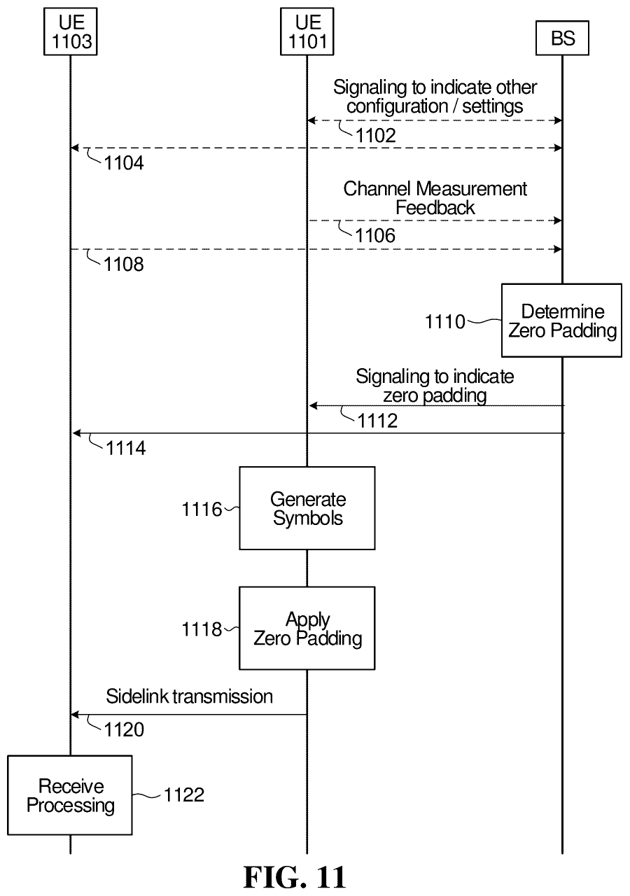

FIG. 11 is a signal flow diagram for sidelink communications according to an embodiment. Embodiments disclosed herein are not limited to communicating zero-padded transmission symbols between particular types of communication devices such as a UE and a BS as shown by way of example in FIGS. 9 and 10. Sidelink communications as shown by way of example in FIG. 11 are also possible.

Optional signaling between each of two UEs 1101, 1103 and a BS are shown at 1102, 1104 and 1106, 1108. This optional signaling is described at least above with reference to 902 and 904 in FIG. 9, but in FIG. 11 is between each UE 1101, 1103 and the BS. Also similar to FIG. 9, at 1110 in FIG. 11 the BS determines the zero padding that is to be applied.

At 1112, 1114, FIG. 11 illustrates communicating signaling indicative of the zero padding to be applied to a transmission symbol. In FIG. 11, however, the signaling is transmitted by the BS to each UE 1101, 1103 and received by each UE from the BS.

The UE 1101 is to transmit a zero-padded transmission symbol in the example shown, and generating a transmission symbol and applying zero padding are shown at 1116, 1118. These operations are also shown in FIG. 9 and described at least above with reference to FIG. 9.

A sidelink transmission is shown at 1120, and transmitting a zero-padded transmission symbol by the UE 1101 to the UE 1103 may involve transmit processing (not shown). At a receive side, operations involve receiving the zero-padded transmission symbol by the UE 1103 from the UE 1101, and receive processing a 1122 may involve such operations as receive counterparts of transmit processing operations, channel estimation, and decoding, for example.

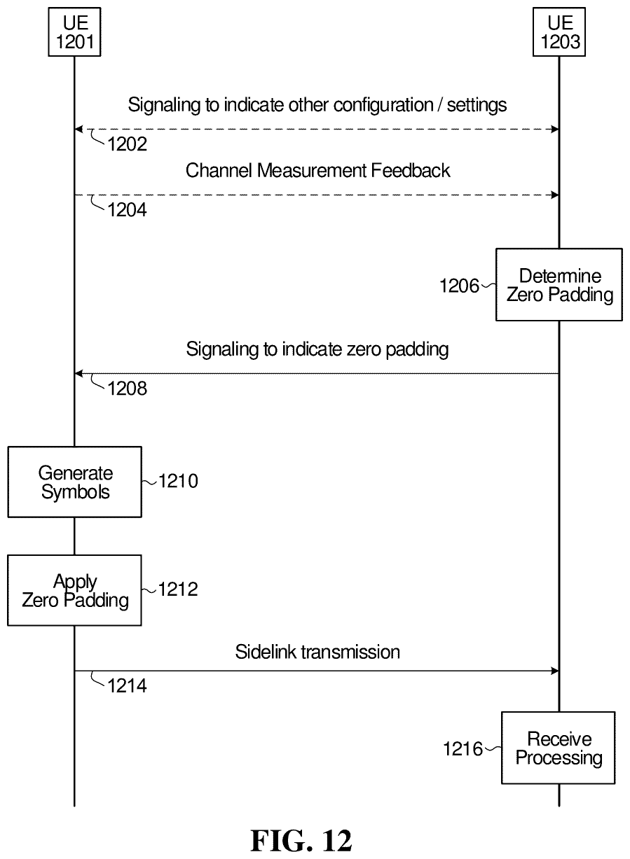

The sidelink communication embodiment in FIG. 11 involve communications between UEs that are controlled and configured by a BS. Embodiments that support direct communications between devices such as UEs need not necessarily involve a network device. NR sidelink, for example, supports a scenario in which UEs autonomously determine the resource that is used for SL data transmission with a sidelink control channel, and no BS is involved. FIG. 12 is a signal flow diagram for sidelink communications according to such an embodiment.

The signaling in FIG. 12 at 1202, 1204, 1208 is similar to the signaling shown at 902, 904, 908 in FIG. 9, with the exception that signaling is between two UEs 1201, 1203 in FIG. 12 instead of between a UE and a BS. It is also the UE 1203 in FIG. 12, rather than a BS, that determines the zero padding at 1206. The signaling to indicate zero padding, at 1208, may be or include sidelink control information (SCI) or PC5 (sidelink RRC) signaling, for example.

Symbol generation and zero padding are shown at 1210, 1212, and are as disclosed elsewhere herein, such as with reference to FIG. 9. Sidelink transmission at 1214 involves the UE 1201 transmitting a zero-padded transmission symbol to the UE 1203, and the UE 1203 receiving the zero-padded transmission symbol from the UE 1201. Other transmit processing (not shown) may also be performed by the UE 1201, and receive processing by the UE 1203 at 1216 may involve receive processing that corresponds to such transmit processing. The receive processing at 1216 may also or instead involve such operations as channel estimation and decoding.

The embodiment shown in FIG. 12 involves one UE (1203) determining the zero padding that is to be applied by another UE (1201). In another embodiment, a transmitting UE that is to transmit a symbol determines the zero padding that is to be applied, and transmits signaling that indicates the zero padding to another UE. Referring to FIG. 12, such an embodiment would involve 1210 and 1212 at the UE 1203 instead of at the UE 1201, a sidelink transmission at 1214 in the opposite direction (from the UE 1203 to the UE 1201), and the receive processing at 1216 at the UE 1201 instead of at the UE 1203.

FIGS. 9 to 12 are illustrative of various embodiments. More generally, a method consistent with the present disclosure may involve communicating signaling in a wireless communication network. The signaling is indicative of zero padding to be applied to a transmission symbol that is to be transmitted in the wireless communication network. A zero-padded transmission symbol to which the zero padding has been applied, and a cyclic prefix preceding the zero-padded transmission symbol, are also communicated.

Communicating signaling may involve transmitting the signaling or receiving the signaling, or, from a network-level perspective, both transmitting the signaling by one communication device and receiving the signaling by another communication device. Similarly, communicating a zero-padded transmission symbol and a CP may involve transmitting, receiving, or both. For example, FIGS. 9 to 12 illustrate embodiments in which communicating signaling involves the following, any one or more of which may be provided or supported by different types of communication devices such as UEs or base stations:
receiving, by a UE, signaling from a BS or another UE, as shown by way of example at 902, 908, 910, 1102, 1104, 1112, 1114, 1202, 1204, 1208;
receiving, by a BS, signaling from a UE, as shown by way of example at 902, 904, 1102, 1104, 1106, 1108;
transmitting, by a UE, signaling to a BS and/or to another UE, as shown by way of example at 902, 904, 1102, 1104, 1106, 1108, 1202, 1204, 1208;
transmitting, by a BS, signaling to one or more UEs, as shown by way of example at 902, 904, 908, 910, 1102, 1104, 1112, 1114.

These examples illustrate that communicating signaling may involve transmitting the signaling by any of various types of first communication device such as a UE or a base station or other network device, to any of various types of second communication device such as a UE or a base station or other network device. Communicating signaling may also or instead involve receiving the signaling at any of various types of first communication device such as a UE or a base station or other network device, from any of various types of second communication device such as a UE or a base station or other network device.

Similar to communicating signaling, communicating a zero-padded transmission symbol and a CP may involve transmitting and/or receiving, by any of various types of communication device such as a UE or a base station or other network device. Embodiments may also or instead involve communicating a reference signal such as a DMRS, as described in more detail at least below, and such communicating may similarly involve transmitting and/or receiving by any of various types of communication device such as a UE or a base station or other network device. Examples of communicating a zero-padded transmission symbol and a CP are shown in FIGS. 9 to 12 as an uplink transmission 916, a downlink transmission 1014, or a sidelink transmission 1120, 1214. Communicating a reference signal may similarly involve transmitting and/or receiving uplink, downlink, or sidelink transmissions.

A receiver or intended receiver (or receiving device) of a zero-padded transmission symbol or reference signal may transmit or receive signaling before a zero-padded transmission symbol or reference signal is received. In FIG. 9, for example, the BS is the intended receiver of a zero-padded transmission symbol and may transmit signaling at 908 before receiving the zero-padded transmission symbol at 916. In FIG. 10, the UE is the intended receiver of a zero-padded transmission symbol and may receive signaling at 908 before receiving the zero-padded transmission symbol at 1014. In FIG. 11, the UE 1103 is the intended receiver of a zero-padded transmission symbol and may receive signaling at 1112 from the BS. In FIG. 12, the UE 1203 is the intended receiver of a zero-padded transmission symbol and may transmit signaling at 1208 to the UE 1201 before receiving a zero-padded transmission symbol at 1214.

Similarly, a transmitter or intended transmitter (or transmitting device) of a zero-padded transmission symbol or a reference signal may transmit or receive signaling before a zero-padded transmission symbol or a reference signal is transmitted. In FIG. 9, for example, the UE is the transmitter of the a zero-padded transmission symbol and may receive signaling at 908 before transmitting the zero-padded transmission symbol at 916. The BS is the transmitter of a zero-padded transmission symbol in FIG. 10, but may transmit signaling at 904 before transmitting the zero-padded transmission symbol 1014. In FIG. 11, the UE 1101 is the transmitter of a zero-padded transmission symbol and may receive signaling at 1112 before transmitting the zero-padded transmission symbol at 1120. In FIG. 12, the UE 1201 is the transmitter of a zero-padded transmission symbol and may receive signaling at 908 from the UE 1203 before transmitting a zero-padded transmission symbol at 1214.

In some embodiments, signaling and a zero-padded transmission symbol or reference signal are communicated between a transmitter and an intended receiver of a DMRS, such as between UE 1201 and UE 1203 in FIG. 12. Thus, in the context of communicating signaling between a first communication device and a second communication device, in such embodiments communicating a DMRS involves communicating the DMRS between the first communication device and the second communication device.

Signaling and a zero-padded transmission symbol or reference signal need not necessarily be communicated between the same devices. Consider FIG. 11 as an example. Signaling is communicated between the BS and the UE 1101 at 1112 and between the BS and the UE 1103 at 1114, but the zero-padded transmission symbol is communicated between the UE 1101 and the UE 1103 at 1120. This is illustrative of embodiments in which signaling and a zero-padded transmission symbol are not communicated between the same devices. In the context of communicating a zero-padded transmission symbol or a reference signal by a first communication device with a second communication device, in such embodiments communicating signaling may involve communicating the signaling by the first communication device (or the second communication device) and a third communication device in the wireless communication network.

These are all illustrative of examples of communicating signaling and communicating a zero-padded transmission symbol. These communicating options may also or instead apply to communicating reference signals.

The embodiments illustrated in FIGS. 9 to 12 are intended to be non-limiting examples. Other embodiments may include fewer, additional, and/or different features.

Consider a method that involves communicating, by a first communication device or a second communication in a wireless communication network, signaling indicative of zero padding to be applied by the first communication device to a transmission symbol that is to be transmitted in the wireless communication network. From a transmit-side perspective, such a method may involve transmitting, by the first communication device to the second communication device, a zero-padded transmission symbol to which the zero padding has been applied and a cyclic prefix preceding the zero-padded transmission symbol. From a receive-side perspective, such a method may involve receiving, by the second communication device from the first communication device, a zero-padded transmission symbol to which the zero padding has been applied and a cyclic prefix preceding the zero-padded transmission symbol.

In the context of a transmit-side method or a receive-side method, any of various features disclosed herein may be provided. For example, any one or more of the following may be provided, in any of various combinations:
the zero-padded transmission symbol may be or include a first number of head zeros padded at the head of the transmission symbol and a second number, different from the first number, of tail zeros padded at the tail of the transmission symbol;
transmitting (or receiving) a zero-padded transmission symbol to which the zero padding has been applied and a cyclic prefix may involve transmitting (or receiving) multiple consecutive zero-padded transmission symbols to which the zero padding has been applied;
the signaling may be indicative of an identifier of one of multiple zero-padding patterns that are available at the first communication device and define respective different patterns of head zero padding and tail zero padding;
the signaling may be indicative of a zero-padding pattern that defines a pattern of the head zero padding and the tail zero padding;
the signaling may be indicative of a number of zeros to be padded in the zero-padded transmission symbol, which may be or include any one or more of: a total number of zeros to be padded in the zero-padded transmission symbol, a number of head zeros to be padded at the head of the transmission symbol, and a number of tail zeros to be padded at the tail of the transmission symbol;
the signaling may be indicative of a ratio between a number of head zeros to be padded at the head of the transmission symbol and a number of tail zeros to be padded at the tail of the transmission symbol;
the zero padding may be consistent with a common zero-padding configuration of communication devices in the wireless communication network, and the zero-padded transmission symbol may include a first number of head zeros padded at the head of the transmission symbol and a second number, larger than the first number, of tail zeros padded at the tail of the transmission symbol;
the first number of head zeros may be padded to provide a target reduction in ISI on the zero-padded transmission symbol by a preceding zero-padded transmission symbol to which the zero padding has been applied, and the second number of tail zeros may be padded to provide a target reduction in ISI on a next zero-padded transmission symbol to which the zero padding has been applied;
the zero padding may be different from zero padding configured for other communication devices in the wireless communication network, and the zero-padded transmission symbol may include a first number of head zeros padded at the head of the transmission symbol and a second number, smaller than the first number, of tail zeros padded at the tail of the transmission symbol;
the first number of head zeros may be padded to provide a target reduction in ISI on the zero-padded transmission symbol by a preceding transmission symbol independent of any zero padding applied to the preceding transmission symbol, and the second number of tail zeros may be padded to provide a target reduction in head-caused interference on the tail of the zero-padded transmission symbol caused by the head of the zero-padded transmission symbol;
options for the signaling are described elsewhere herein, and the signaling may be or include any one or more of: MIB signaling, SIB signaling, numerology configuration signaling, broadcast signaling, multi-cast signaling, RRC signaling, DCI, and SCI;
communicating the signaling may involve transmitting the signaling by the first communication device to the second communication device;
communicating the signaling may involve receiving the signaling by the first communication device from the second communication device;
communicating the signaling may involve receiving the signaling by the first communication device from a third communication device;
communicating the signaling may involve receiving the signaling by the second communication device from the first communication device;
communicating the signaling may involve transmitting the signaling by the second communication device to the first communication device;
communicating the signaling may involve receiving the signaling by the second communication device from a third communication device.

These method examples are illustrative and non-limiting embodiments, and other embodiments may include additional or different features disclosed herein.

Embodiments are described above primarily in the context of zero padding for transmission symbols. Zero padding, however, may have other effects or applications.

For example, consider that when zero padding is used for data signals, it may also be applied to reference signals, such as a demodulation reference signal (DMRS) that is used for channel estimation. There may be specific considerations for reference signal (RS) design in the context of zero padding.

The length of an RS sequence, which is used to generate an RS, can be shorter than the length to which a transmission symbol is zero padded. In some embodiments the length of an RS sequence is less than the length of a data sequence that is included in a zero-padded transmission symbol, shown as non-zero data in FIGS. 6 and 7. This is not always necessarily the case, but can result in two effects. For example, an RS sequence that is shorter than a data sequence but is zero padded to the same length as a zero-padded transmission symbol that includes the shorter data sequence can have better ISI protection than data. It may also enable a shorter ZC sequence, or other sequence, to be used as an RS sequence, and it may be possible to use a sequence of prime length for RS generation. With zero padding of an RS sequence, there might be no need to cyclically repeat a ZC (or other) sequence so that it can be of the same length as a zero-padded transmission symbol. Zero padding of an RS sequence may avoid, or at least reduce, an amount by which an RS sequence is extended by cyclic repetition.

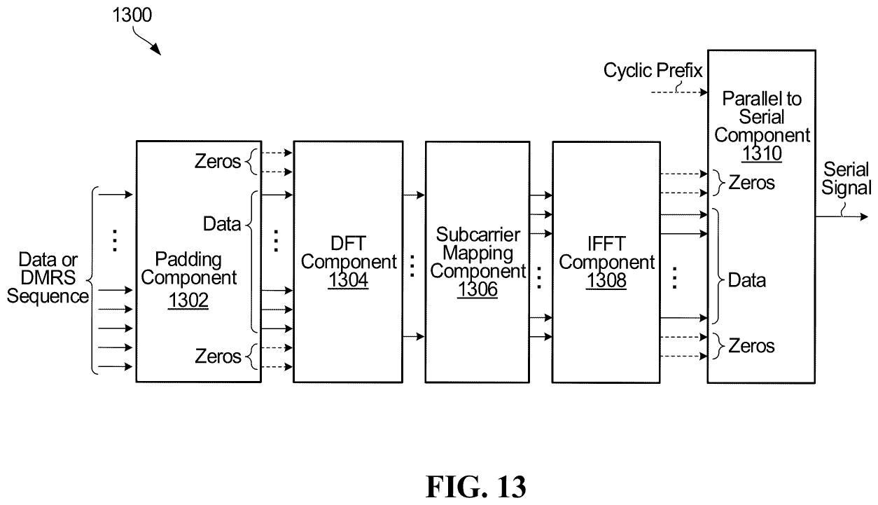

FIG. 13 is a block diagram illustrating an example transmitter according to an embodiment. The transmitter 1300 is an example for DFT-s-OFDM. It is to be understood that components in FIG. 13 may implement a transmit function of a wireless device or a network device such as a base station. The example transmitter 1300 includes a padding component 1302, a DFT component 1304, a subcarrier mapping component 1306, an inverse fast Fourier transform (IFFT) component 1308, and a parallel to serial component 1310, interconnected as shown. Other embodiments may include additional, fewer, or different elements interconnected in a similar or different way. It also to be understood that the components in the example transmitter 1300 are very specific for the sole purpose of illustration of an embodiment.

The elements shown in FIG. 13 may be implemented in any of various ways, such as in hardware, firmware, or one or more components that execute software. As noted elsewhere herein, the present disclosure is not limited to any specific type of implementation, and implementation details may vary between different devices, for example.

Operation of the example transmitter 1300 will now be described by way of example. The padding component 1300 is configured, by executing software for example, to zero pad a data sequence, or an RS sequence shown by way of example as a DMRS sequence. Zero padding for a data sequence is as described in detail elsewhere herein, and includes both head zeros and tail zeros. Zero padding is also applied to an RS sequence, and RS sequence zero padding may be the same as data sequence zero padding or different from data sequence padding. For example, exactly the same zero padding may be used for a data sequence and an RS sequence that have the same non-padded length and are to be padded to the same padded length. If an RS sequence is of a different length than a data sequence, then RS sequence zero padding may be based on, but have a different length than, a zero-padding pattern for data padding. As a different-length example, RS sequence zero padding and data sequence zero padding may both be head- weighted or tail-weighted zero padding, but with different numbers of zeros for RS sequence zero padding and data sequence zero padding.

Before zero-padded data or a zero-padded RS sequence that has been zero padded is transmitted, it is mapped in the frequency domain to a frequency sub-band. To this end, the DFT component 1304 is configured, by executing software for example, to transform the zero-padded data or RS sequence from time domain into a frequency domain, and the subcarrier mapping component 1306 is configured, by executing software for example, to map the zero-padded data or RS sequence in the frequency domain to the frequency sub-band. The IFFT component 1308 is configured, by executing software for example, to transform the zero-padded and frequency mapped data or RS sequence back from the frequency domain to the time domain. The parallel to serial component 1310 is configured, by executing software for example, to perform conversion into a serial signal for transmission over a communication channel. Note that the cyclic prefix is fed into the serial signal by the parallel to serial component 1310 along with the data and zero padding, and thus the parallel to serial component handles CP insertion in the example shown. A separate CP inserter may be used in other embodiments.

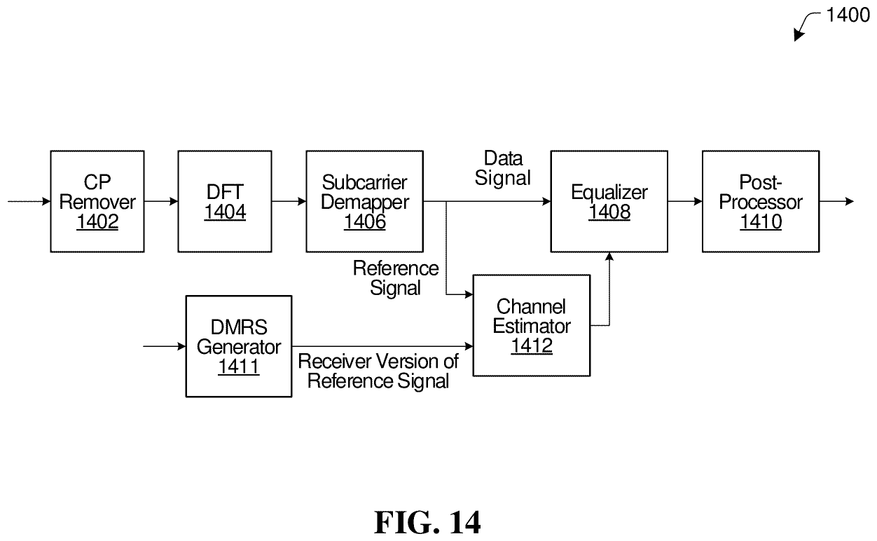

FIG. 14 is a block diagram illustrating an example receiver according to an embodiment. The example receiver 1400 includes a CP remover 1402, a DFT block 1404, a subcarrier demapper 1406, an equalizer 1408, a post-processor 1410, a DMRS generator 1411, and a channel estimator 1412, interconnected as shown. Other embodiments may include additional, fewer, or different elements interconnected in a similar or different way.

The elements shown in FIG. 14 may be implemented in any of various ways, such as in hardware, firmware, or one or more components that execute software. As noted elsewhere herein, the present disclosure is not limited to any specific type of implementation, and implementation details may vary between different devices, for example.

Receiver operations may include CP removal, conversion to frequency domain by a DFT, subcarrier demapping and demultiplexing a data signal and a reference signal, channel estimation based on a received reference signal and a locally generated receiver version of the reference signal, equalization of the data signal based on channel estimates, and any of various types of post-processing, such as further processing based on transmitter precoding for example.

In the example receiver 1400, the CP remover 1402 is configured, by executing software for example, to remove the cyclic prefix; the DFT block 1404 is configured, by executing software for example, to perform a DFT to convert a received time domain signal to frequency domain; the subcarrier demapper 1406 is configured, by executing software for example, to perform subcarrier demapping; the equalizer 1408 is configured, by executing software for example, to equalize a data portion of the output of the subcarrier demapper 1406; the channel estimator 1412 is configured, by executing software for example, to process a reference signal portion of the output of the subcarrier demapper 1406 and a receiver version of the reference signal generated by the DMRS generator 1411 to produce channel estimates that are provided to the equalizer 1408; and the post-processor 1410 is configured, by executing software for example, to process the output of the equalizer. The channel estimator 1412 receives a receiver version of the reference signal from the DMRS generator 1411 for channel estimation in the example receiver 1400. More generally, the channel estimator 1412 receives, determines, or otherwise obtains the same base sequence or DMRS as a transmitter and then uses it to perform channel estimation. The post-processor 1410 may take into account any transmit processing performed at a transmitter, for example.

Like FIG. 13, FIG. 14 is an illustrative and non-limiting example.

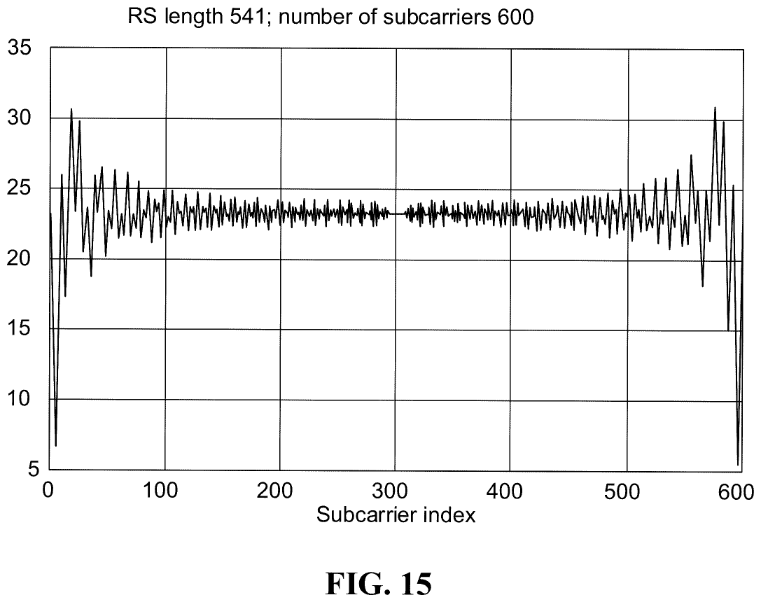

Regarding a reference signal such as a DMRS, although ZC sequences are flat in both time domain and frequency domain, and it is preferred that an RS is also flat in frequency domain, an RS sequence with zero padding will not be flat in frequency domain. As shown in FIG. 15, which illustrates a frequency domain plot of a zero-padded ZC sequence, there are some ripples towards the edges of the occupied band, and channel estimation at some low amplitude subcarriers can cause severe noise enhancement. Considering that the channel in the frequency domain is correlated (i.e., coherence bandwidth of the channel), and the up-sampled RS has a generally saw-toothed pattern, channel estimation at deep notch subcarriers can be done by interpolating or reusing estimates from nearby subcarriers, which have higher amplitudes and better SNR. Note that FIG. 15 relates to an example in which a ZC sequence has a non-padded length of 541, and the DFT size is 600. With zero padding from length 541 to match the DFT size of 600, which would also be the length of a zero-padded transmission symbol size in this example, approximately 10% of pulses are set to zero. When fewer pulses are set to zero, the ripples in the frequency domain will also be smaller.

With zero padding, some time-domain head samples are set to zero, as shown at 1302 in FIG. 13 for example. Otherwise, ISI can affect frequency domain channel estimation. One or more tail samples may also be set to zero. For channel estimation at a receiver, channel interpolation can be used for notch points at the band edges, due to the general “V” shape in up-sampled ZC sequence notches. For data symbol detection, there is no need for such interpolation, because ISI can be ignored after equalization at 1408, for example.

This type of approach to reference signals has benefits in providing not only better protection for reference signals by using zero padding, but also better channel estimation because estimates obtained via interpolation avoids the noise-enhancement effect if a deep-notch pilot is used. These benefits can be achieved by decoupling the RS length from non-padded data length, and using channel interpolation rather than deep-notch pilot-based estimation.

According to an embodiment related to zero padding for reference signals, a method may involve communicating, by a first communication device or a second communication device in a wireless communication network, signaling indicative of zero padding to be applied by the first communication device to a transmission symbol that is to be transmitted in the wireless communication network. Such a method may also involve transmitting, by the first communication device to a second communication device, a zero-padded transmission symbol and a reference signal for channel estimation. From a receive-side perspective, a method may involve receiving, by the second communication device from the first communication device, a zero-padded transmission symbol and a reference signal for channel estimation. Zero padding has been applied to the zero-padded transmission symbol, and the reference signal is based on a sequence that is shorter than the zero-padded transmission symbol and is zero padded to a same length as the zero-padded transmission symbol.

In some embodiments, the zero padding applied to the zero-padded transmission symbol is also applied to the sequence upon which the reference signal is based, to zero pad the sequence to the same length as the zero-padded transmission symbol. This may involve using exactly the same zero-padding pattern for transmission symbol padding and RS sequence padding, or the same pattern but different padding lengths for transmission symbol padding and RS sequence padding, for example. Transmission symbol padding and RS sequence padding may, but need not necessarily, be the same.

Another optional feature provided in some embodiments is that the sequence upon which the reference signal is based is a prime length sequence.

At a receive side, a method may also involve performing, by the second communication device in the example above, channel estimation based on the reference signal and interpolation of low amplitude subcarriers caused by the sequence having been zero padded. These low amplitude subcarriers are at the band edges in FIG. 15, for example.

Other features disclosed herein, including those disclosed in the context of zero padding for transmission symbols, may also or instead be provided or supported in embodiments that involve RS sequence zero padding. Such features may be applied to transmission symbol zero padding, RS sequence zero padding, or both.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

An apparatus may include a processor and a non-transitory computer readable storage medium, coupled to the processor, storing programming for execution by the processor. In FIG. 3, for example, the processors 210, 260, 276 may each be or include one or more processors, and each memory 208, 258, 278 is an example of a non-transitory computer readable storage medium, in an ED 110 and a TRP 170, 172. A non-transitory computer readable storage medium need not necessarily be provided only in combination with a processor, and may be provided separately in a computer program product, for example.

As an illustrative example, programming stored in or on a non-transitory computer readable storage medium may include instructions to, or to cause a processor to, communicate signaling between a first communication device and a second communication device in a wireless communication network. The signaling is indicative of zero padding to be applied to a transmission symbol that is to be transmitted in the wireless communication network by the first communication. The programming may include instructions to, or to cause the processor to, transmit by the first communication device to the second communication device (or receive by the second communication device from the first communication device) a zero-padded transmission symbol to which the zero padding has been applied and a cyclic prefix preceding the zero-padded transmission symbol. The zero padding may include both head zero padding at a head of the transmission symbol and tail zero padding at a tail of the transmission symbol.

In some embodiments, programming may include instructions to, or to cause a processor to, transmit by the first communication device to the second communication device (or receive by the second communication device from the first communication device) a zero-padded transmission symbol to which the zero padding has been applied, and a reference signal for channel estimation. The reference signal is based on a sequence that is shorter than the zero-padded transmission symbol and is zero padded to a same length as the zero-padded transmission symbol.

Embodiments related to apparatus or non-transitory computer readable storage media may include any one or more of the following features, for example, which are also discussed elsewhere herein:
the zero-padded transmission symbol may be or include a first number of head zeros padded at the head of the transmission symbol and a second number, different from the first number, of tail zeros padded at the tail of the transmission symbol;
the programming may include instructions to, or to cause a processor to, transmit (or receive) multiple consecutive zero-padded transmission symbols to which the zero padding has been applied;
the signaling may be indicative of an identifier of one of multiple zero-padding patterns that are available at the first communication device and define respective different patterns of head zero padding and tail zero padding;
the signaling may be indicative of a zero-padding pattern that defines a pattern of the head zero padding and the tail zero padding;
the signaling may be indicative of a number of zeros to be padded in the zero-padded transmission symbol, which may be or include any one or more of: a total number of zeros to be padded in the zero-padded transmission symbol, a number of head zeros to be padded at the head of the transmission symbol, and a number of tail zeros to be padded at the tail of the transmission symbol;
the signaling may be indicative of a ratio between a number of head zeros to be padded at the head of the transmission symbol and a number of tail zeros to be padded at the tail of the transmission symbol;
the zero padding may be consistent with a common zero-padding configuration of communication devices in the wireless communication network, and the zero-padded transmission symbol may include a first number of head zeros padded at the head of the transmission symbol and a second number, larger than the first number, of tail zeros padded at the tail of the transmission symbol;
the first number of head zeros may be padded to provide a target reduction in ISI on the zero-padded transmission symbol by a preceding zero-padded transmission symbol to which the zero padding has been applied, and the second number of tail zeros may be padded to provide a target reduction in ISI on a next zero-padded transmission symbol to which the zero padding has been applied;
the zero padding may be different from zero padding configured for other communication devices in the wireless communication network, and the zero-padded transmission symbol may include a first number of head zeros padded at the head of the transmission symbol and a second number, smaller than the first number, of tail zeros padded at the tail of the transmission symbol;
the first number of head zeros may be padded to provide a target reduction in ISI on the zero-padded transmission symbol by a preceding transmission symbol independent of any zero padding applied to the preceding transmission symbol, and the second number of tail zeros may be padded to provide a target reduction in head-caused interference on the tail of the zero-padded transmission symbol caused by the head of the zero-padded transmission symbol;
options for the signaling are described elsewhere herein, and the signaling may be or include any one or more of: MIB signaling, SIB signaling, numerology configuration signaling, broadcast signaling, multi-cast signaling, RRC signaling, DCI, and SCI;
the programming may include instructions to, or to cause a processor to, communicate the signaling by transmitting the signaling to the second communication device;
the programming may include instructions to, or to cause a processor to, communicate the signaling by receiving the signaling from the second communication device;
the programming may include instructions to, or to cause a processor to, communicate the signaling by receiving the signaling from a third communication device;
the programming may include instructions to, or to cause a processor to, communicate the signaling by receiving the signaling from the first communication device;
the programming may include instructions to, or to cause a processor to, communicate the signaling by transmitting the signaling to the first communication device;
the programming may include instructions to, or to cause a processor to, communicate the signaling by receiving the signaling from a third communication device;
the zero padding applied to the zero-padded transmission symbol may also have been applied to the sequence on which the reference signal is based, to zero pad the sequence to the same length as the zero-padded transmission symbol;
the sequence on which the reference signal is based is a prime length sequence;
the programming may include instructions to, or to cause a processor to: perform, by the second communication device, channel estimation based on the reference signal and interpolation of low amplitude subcarriers caused by the sequence having been zero padded.

The present disclosure encompasses zero padding for common or fixed configuration scenario, in which head data in one symbol will not cause high interference to a next symbol due to head zero-padding, and there will be more tail zeros than head zeros to collect multi-path energy in the tail padding region.

Zero padding for a scenario in which different zero-padding configurations are used is also possible. By allocating more zeros to the head of a symbol than the tail, more guard interval is allocated in a current symbol, and thus better ISI self-protection may be achieved when a device that transmits a previous or symbol uses different zero padding, or no zero padding at all.

Proposed zero padding patterns or rules may address ISI, user self-protection, and multi-path energy collection, which should help enhance system performance.

According to embodiments related to reference signal design, the length of an RS sequence does not need to be the same as the length of a non-padded data sequence. Decoupling the length of an RS sequence from that of data can provide flexibility in selecting RS sequences. In some embodiments, RS length is shorter than data length, so as to provide better protection to channel estimation.

When a ZC sequence is used, for example, head and tail zero padding creates ripples in the frequency domain near the edges of the occupied sub-band, but the generally saw-toothed pattern of the ripple and interpolation-based channel estimation make this ripple manageable. Such channel interpolation is used in some embodiments instead of using deep-notch pilots for channel estimation.

Associated signaling mechanisms are also disclosed, and are intended to optimize or at least improve system performance while minimizing or at least reducing signaling overhead. Zero padding patterns or rules may be specified in communication standards, for example, so that signaling can be based on such pre-defined patterns. This may help avoid signaling becoming more complex.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

Features disclosed herein in the context of method embodiments, for example, may also or instead be implemented in apparatus or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Disclosed embodiments are also not intended to be limited to any particular applications. For example, the proposed solutions can be used in integrated sensing and communication (ISAC) as well. In ISAC, reflected paths need to fall in the CP region, so that they do not cause ISI to each other. When CP length is not long enough to accommodate the reflected paths, zero padding can be used to create addition guard room. This type of application may be appropriate, for example, for use of DFT-s-OFDM/SC-OQAM in ISAC.

Although aspects of the present invention have been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although embodiments and potential advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer readable or processor readable storage medium or media for storage of information, such as computer readable or processor readable instructions, data structures, program modules, and/or other data. A non-exhaustive list of examples of non-transitory computer readable or processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and nonremovable media implemented in any method or technology, random-access memory (RAM), read-only memory (ROM), electrically erasable programmable read-only memory (EEPROM), flash memory or other memory technology. Any such non-transitory computer readable or processor readable storage media may be part of a device or accessible or connectable thereto. Any application or module herein described may be implemented using instructions that are readable and executable by a computer or processor may be stored or otherwise held by such non-transitory computer readable or processor readable storage media.

What is claimed is:

1. A method comprising:
communicating, in a wireless communication network, signaling indicative of zero padding to be applied to a transmission symbol that is to be transmitted in the wireless communication network, the zero padding comprising head zero padding at a head of the transmission symbol and tail zero padding at a tail of the transmission symbol; and
communicating, in the wireless communication network, a zero-padded transmission symbol to which the zero padding has been applied, and a cyclic prefix preceding the zero-padded transmission symbol.

2. The method of claim 1, wherein the zero-padded transmission symbol comprises a first number of head zeros padded at the head of the transmission symbol and a second number, different from the first number, of tail zeros padded at the tail of the transmission symbol.

3. The method of claim 1, wherein the communicating the zero-padded transmission symbol comprises transmitting a plurality of consecutive zero-padded transmission symbols to which the zero padding has been applied.

4. The method of claim 1, wherein the signaling is indicative of any one or more of:
an identifier of a zero-padding pattern of a plurality of available zero-padding patterns, and each zero-padding pattern defining respective different patterns of head zero padding and tail zero padding;
a zero-padding pattern that defines a pattern of the head zero padding and the tail zero padding;
a number of zeros to be padded in the zero-padded transmission symbol, the number of zeros comprising any one or more of: a total number of zeros to be padded in the zero-padded transmission symbol, a number of head zeros to be padded at the head of the transmission symbol, or a number of tail zeros to be padded at the tail of the transmission symbol; or
a ratio between a number of head zeros to be padded at the head of the transmission symbol and a number of tail zeros to be padded at the tail of the transmission symbol.

5. The method of claim 1,
wherein the zero padding is consistent with a common zero-padding configuration of a plurality of communication devices in the wireless communication network, and
wherein the zero-padded transmission symbol comprises a first number of head zeros padded at the head of the transmission symbol and a second number, larger than the first number, of tail zeros padded at the tail of the transmission symbol.

6. The method of claim 5,
wherein the first number of head zeros is configured to provide a first target reduction in inter-symbol interference (ISI) on the zero-padded transmission symbol by a preceding zero-padded transmission symbol to which the zero padding has been applied, and
wherein the second number of tail zeros is configured to provide a second target reduction in ISI on a next zero-padded transmission symbol to which the zero padding has been applied.

7. The method of claim 1,
wherein the zero padding is different from another zero padding configured for a communication device in the wireless communication network, and
wherein the zero-padded transmission symbol comprises a first number of head zeros padded at the head of the transmission symbol and a second number, smaller than the first number, of tail zeros padded at the tail of the transmission symbol.

8. The method of claim 7,
wherein the first number of head zeros is configured to provide a first target reduction in inter-symbol interference (ISI) on the zero-padded transmission symbol by a preceding transmission symbol independent of any zero padding applied to the preceding transmission symbol, and
wherein the second number of tail zeros is configured to provide a second target reduction in head-caused interference on the tail of the zero-padded transmission symbol caused by the head of the zero-padded transmission symbol.

9. An apparatus comprising:
at least one processor; and
a non-transitory computer readable storage medium, coupled to the at least one processor, storing programming for execution by the at least one processor, the programming including instructions to:
communicate, in a wireless communication network, signaling indicative of zero padding to be applied to a transmission symbol that is to be transmitted in the wireless communication network, the zero padding comprising head zero padding at a head of the transmission symbol and tail zero padding at a tail of the transmission symbol; and
communicate, in the wireless communication network, a zero-padded transmission symbol to which the zero padding has been applied, and a cyclic prefix preceding the zero-padded transmission symbol.

10. The apparatus of claim 9, wherein the zero-padded transmission symbol comprises a first number of head zeros padded at the head of the transmission symbol and a second number, different from the first number, of tail zeros padded at the tail of the transmission symbol.

11. The apparatus of claim 9, wherein the programming including instructions to communicate the zero-padded transmission symbol comprises the programming including instructions to transmit a plurality of consecutive zero-padded transmission symbols to which the zero padding has been applied.

12. The apparatus of claim 9, wherein the signaling is indicative of any one or more of:
an identifier of a zero-padding pattern of a plurality of zero-padding patterns that are available at the apparatus and define respective different patterns of head zero padding and tail zero padding;
a zero-padding pattern that defines a pattern of the head zero padding and the tail zero padding;
a number of zeros to be padded in the zero-padded transmission symbol, the number of zeros comprising any one or more of: a total number of zeros to be padded in the zero-padded transmission symbol, a number of head zeros to be padded at the head of the transmission symbol, or a number of tail zeros to be padded at the tail of the transmission symbol; or
a ratio between a number of head zeros to be padded at the head of the transmission symbol and a number of tail zeros to be padded at the tail of the transmission symbol.

13. The apparatus of claim 9,
wherein the zero padding is consistent with a common zero-padding configuration of a plurality of communication devices in the wireless communication network, and
wherein the zero-padded transmission symbol comprises a first number of head zeros padded at the head of the transmission symbol and a second number, larger than the first number, of tail zeros padded at the tail of the transmission symbol.

14. The apparatus of claim 13,
wherein the first number of head zeros is configured to provide a first target reduction in inter-symbol interference (ISI) on the zero-padded transmission symbol by a preceding zero-padded transmission symbol to which the zero padding has been applied, and
wherein the second number of tail zeros is configured to provide a second target reduction in ISI on a next zero-padded transmission symbol to which the zero padding has been applied.

15. The apparatus of claim 9,
wherein the zero padding is different from another zero padding configured for a communication device in the wireless communication network, and
wherein the zero-padded transmission symbol comprises a first number of head zeros padded at the head of the transmission symbol and a second number, smaller than the first number, of tail zeros padded at the tail of the transmission symbol.

16. The apparatus of claim 15,
wherein the first number of head zeros is configured to provide a first target reduction in inter-symbol interference (ISI) on the zero-padded transmission symbol by a preceding transmission symbol independent of any zero padding applied to the preceding transmission symbol, and
wherein the second number of tail zeros is configured to provide a second target reduction in head-caused interference on the tail of the zero-padded transmission symbol caused by the head of the zero-padded transmission symbol.

17. A method comprising:
communicating, in a wireless communication network, signaling indicative of zero padding to be applied to a transmission symbol that is to be transmitted in the wireless communication network; and
communicating, in the wireless communication network, a zero-padded transmission symbol to which the zero padding has been applied, and a reference signal for channel estimation, the reference signal being based on a sequence that is shorter than the zero-padded transmission symbol and that is zero padded to a same length as the zero-padded transmission symbol.

18. The method of claim 17, the zero padding having also been applied to the sequence to zero pad the sequence to the same length as the zero-padded transmission symbol.

19. An apparatus comprising:
at least one processor; and
a non-transitory computer readable storage medium, coupled to the at least one processor, and storing programming for execution by the at least one processor, the programming including instructions to:
communicate, in a wireless communication network, signaling indicative of zero padding to be applied to a transmission symbol that is to be transmitted in the wireless communication network; and
communicate, in the wireless communication network, a zero-padded transmission symbol to which the zero padding has been applied, and a reference signal for channel estimation, the reference signal being based on a sequence that is shorter than the zero-padded transmission symbol and is zero padded to a same length as the zero-padded transmission symbol.

20. The apparatus of claim 19, the zero padding having also been applied to the sequence to zero pad the sequence to the same length as the zero-padded transmission symbol.
